(19) United States
(12) Patent Application Publication
(10) Pub. No.: US 2019/0286792 A1
(43) Pub. Date: Sep. 19, 2019

(54) CHEMICAL COMPOUND DISCOVERY USING MACHINE LEARNING TECHNOLOGIES

(71) Applicant: International Business Machines Corporation, Armonk, NY (US)

(72) Inventors: Yan Li, Mountain View, CA (US); Heng Luo, Ossining, NY (US); Wendy Dawn Cornell, Warren, NJ (US); Ping Zhang, White Plains, NY (US)

(21) Appl. No.: 15/920,290

(22) Filed: Mar. 13, 2018

(51) Int. Cl. G06F 19/00; G06F 17/18; G06N 5/04; G06N 99/00

(52) U.S. Cl. CPC G06F 19/707; G06F 17/18; G06F 2217/16; G06N 99/005; G06N 5/04

(57) ABSTRACT

Techniques regarding efficient means for chemical compound discovery are provided. For example, one or more embodiments can regard a system, which can comprise a memory that stores computer executable components and a processor, operably coupled to the memory, that can execute the computer executable components stored in the memory. The computer executable components can comprise a test component that can determine a first parameter value of a tested chemical compound from a plurality of chemical compounds. Additionally, a model component can generate a regression analysis model using a value information analysis. The regression analysis model can regard the plurality of chemical compounds based on the first parameter value. Further, an identification component can identify a preferred chemical compound from the plurality of chemical compounds based on the regression analysis model. A second parameter value of the preferred chemical compound can be greater than a defined threshold.

### BACKGROUND

The subject disclosure relates to one or more computer models that can facilitate chemical compound discovery, and more specifically, to one or more computer models that can facilitate an efficient feature analysis of one or more subject chemical compounds.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatuses and/or computer program products that can generate one or more models, which can facilitate an efficient feature analysis of one or more subject chemical compounds, are described.

According to an embodiment, a system is provided. The system can comprise a memory that stores computer executable components. Further, the system can comprise a processor, operably coupled to the memory, and that can execute the computer executable components stored in the memory. The computer executable components can comprise a test component that can determine a first parameter value of a tested chemical compound from a plurality of chemical compounds. The computer executable components can also comprise a model component that can generate a regression analysis model using a value information analysis. The regression analysis model can regard the plurality of chemical compounds based on the first parameter value. Further, the computer executable components can comprise an identification component that can identify a preferred chemical compound from the plurality of chemical compounds based on the regression analysis model. A second parameter value of the preferred chemical compound can be greater than a defined threshold.

According to another embodiment, a computer-implemented method is provided. The computer-implemented method can comprise determining, by a system operatively coupled to a processor, a first parameter value of a tested chemical compound from a plurality of chemical compounds. The computer-implemented method can also comprise generating, by the system, a regression analysis model using a value information analysis. The regression analysis model can regard the plurality of chemical compounds based on the first parameter value. Further, the computer-implemented method can comprise identifying, by the system, a preferred chemical compound from the plurality of chemical compounds based on the regression analysis model. Also, a second parameter value of the preferred chemical compound can be greater than a defined threshold.

According to another embodiment, a computer program product for chemical compound discovery is provided. The computer program product can comprise a computer readable storage medium having program instructions embodied therewith. The program instructions can be executable by a processor to cause the processor to determine a first parameter value of a tested chemical compound from a plurality of chemical compounds. The program instructions can further cause the processor to generate a regression analysis model using a value information analysis. The regression analysis model can regard the plurality of chemical compounds based on the first parameter value. Also, the program instructions can cause the processor to identify a preferred chemical compound from the plurality of chemical compounds based on the regression analysis model. A second parameter value of the preferred chemical compound can be greater than a defined threshold.

### BRIEF DESCRIPTION OF THE DRAWINGS

FIG. 1 depicts a cloud computing environment in accordance with one or more embodiments described herein.

FIG. 2 depicts abstraction model layers in accordance with one or more embodiments described herein.

FIG. 3 illustrates a block diagram of an example, non-limiting system that can generate one or models and conduct a feature analysis of one or more chemical compounds in accordance with one or more embodiments described herein.

FIG. 4 illustrates a diagram of an example, non-limiting model that can be generated by one or more systems in accordance with one or more embodiments described herein.

FIG. 5 illustrates a block diagram of an example, non-limiting system that can generate one or models and conduct a feature analysis of one or more chemical compounds in accordance with one or more embodiments described herein.

FIG. 6A illustrates a diagram of an example, non-limiting model that can be generated by one or more systems in accordance with one or more embodiments described herein.

FIG. 6B a diagram of an example, non-limiting model that can be generated by one or more systems in accordance with one or more embodiments described herein.

FIG. 7 illustrates a diagram of an example, non-limiting graph that can demonstrate the efficiency and/or efficacy of one or more systems in accordance with one or more embodiments described herein.

FIG. 8 illustrates a flow diagram of an example, non-limiting method that can facilitate generating one or more models that can facilitate in feature analysis of chemical compounds in accordance with one or more embodiments described herein.

FIG. 9 illustrates a flow diagram of an example, non-limiting method that can facilitate generating one or more models that can facilitate in feature analysis of chemical compounds in accordance with one or more embodiments described herein.

FIG. 10 illustrates a block diagram of an example, non-limiting operating environment in which one or more embodiments described herein can be facilitated.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

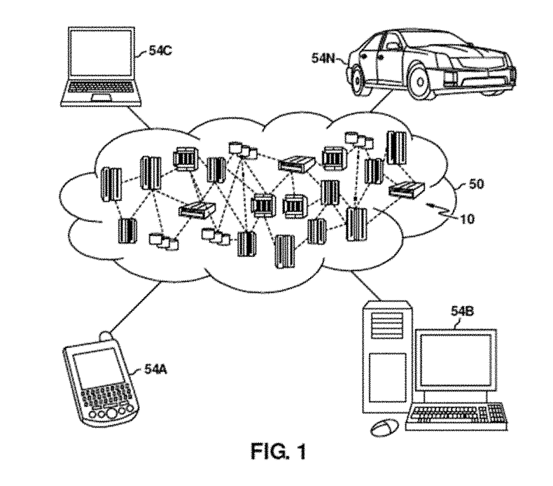

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

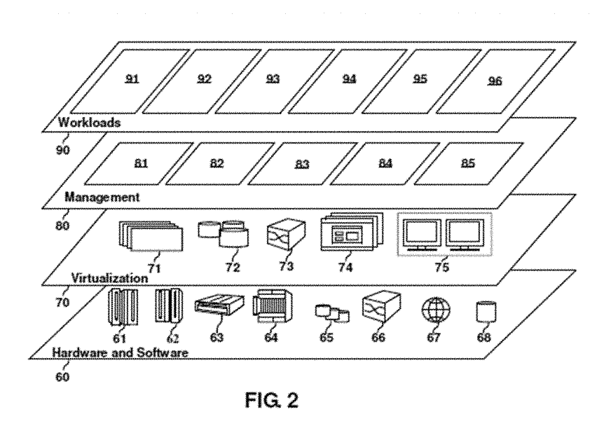

Referring now to FIG. 2, a set of functional abstraction layers provided by cloud computing environment 50 (FIG. 1) is shown. Repetitive description of like elements employed in other embodiments described herein is omitted for sake of brevity. It should be understood in advance that the components, layers, and functions shown in FIG. 2 are intended to be illustrative only and embodiments of the invention are not limited thereto. As depicted, the following layers and corresponding functions are provided. Repetitive description of like elements employed in other embodiments described herein is omitted for sake of brevity.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and chemical compound analysis 96. Various embodiments of the present invention can utilize the cloud computing environment described with reference to FIGS. 1 and 2 to collect data, generate one or more models, and/or facilitate feature analysis of one or more chemical compounds.

Chemical compound analysis can be performed to facilitate numerous technological fields interested in identifying chemical compounds as candidates for various new applications. For example, the pharmaceutical industry uses chemical compound analyses to discover which chemical compounds can serve as candidates to facilitate a particular performance characteristic, such as binding to a target protein. Conventional chemical compound analysis techniques can entail randomly selecting chemical compounds for testing; thereby necessitating numerous wet experiments to screen the potential chemical compounds. Said screening processes can be associated with high costs (e.g., economic and/or opportunity costs). Additionally, conventional computational methods to facilitate the screening processes comprise static models that approach the analysis as a classification problem, thereby identifying potential candidates without regard to the quality of candidacy (e.g., which candidates, amongst the identified potential candidates, are most likely to be suitable for the subject application) or reason for their candidacy (e.g., why the subject candidate exhibits favorable performance characteristics).

Various embodiments of the present invention can be directed to computer processing systems, computer-implemented methods, apparatus and/or computer program products that facilitate the efficient, effective, and autonomous (e.g., without direct human guidance) feature analysis of one or more chemical compounds. For example, in one or more embodiments described herein can regard utilizing a value information analysis to select potential chemical compounds for further testing, and thereby efficiently increase the accuracy of predictions. For instance, one or more embodiments described herein can regard generating one or more models that can facilitate in predicting one or more parameter values. Said models can facilitate predicting the parameter values of untested chemical compounds. Additionally, said models can facilitate in identifying chemical substructures that are likely to affect a chemical compound's parameter value. Further, one or more embodiments can regard generating a ranking comprising, for example, analyzed and unanalyzed chemical compounds based on known and/or predicted parameter values associated with said chemical compounds.

The computer processing systems, computer-implemented methods, apparatus and/or computer program products employ hardware and/or software to solve problems that are highly technical in nature (e.g., generating one or more models to predict parameter values of untested chemical compounds and/or select particular untested chemical compounds for further testing), that are not abstract and cannot be performed as a set of mental acts by a human. For example, a human, or even a plurality of humans, cannot efficiently perform a value of information analysis on a multitude of chemical compounds as described herein. For instance, a human cannot apply a knowledge gradient algorithm to one or more characteristics of a vast amount of untested chemical compounds as efficiently and/or accurately as the one or more embodiments described herein. Further, a human cannot readily, and/or economically, generate and/or update a model based on predicted parameter values and testing reiterations in accordance with the one or more embodiments described herein.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware based systems that perform the specified functions or acts or carry out combinations of special purpose hardware and computer instructions.

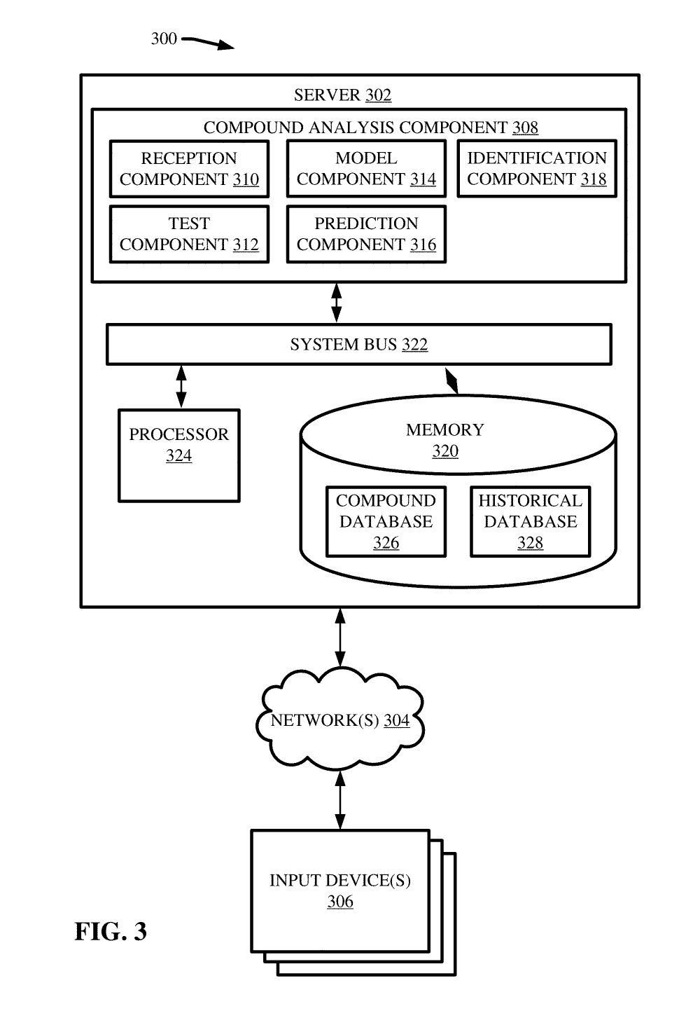

FIG. 3 illustrates a block diagram of an example, non-limiting system 300 that can generate one or more models, which can facilitate identifying trends associated with chemical compound interactions with a target protein. Repetitive description of like elements employed in other embodiments described herein is omitted for sake of brevity. Aspects of systems (e.g., system 300 and the like), apparatuses or processes in various embodiments of the present invention can constitute one or more machine-executable components embodied within one or more machines, e.g., embodied in one or more computer readable mediums (or media) associated with one or more machines. Such components, when executed by the one or more machines, e.g., computers, computing devices, virtual machines, etc. can cause the machines to perform the operations described.

As shown in FIG. 3, the system 300 can comprise one or more servers 302, one or more networks 304, and/or one or more input devices 306. The server 302 can comprise compound analysis component 308, which can further comprise reception component 310, test component 312, model component 314, prediction component 316, and/or identification component 318. Also, the server 302 can comprise or otherwise be associated with at least one memory 320. The server 302 can further comprise a system bus 322 that can couple to various components such as, but not limited to, the compound analysis component 308 and associated components, memory 320 and/or a processor 324. While a server 302 is illustrated in FIG. 3, in other embodiments, multiple devices of various types can be associated with or comprise the features shown in FIG. 3. Further, the server 302 can communicate with the cloud environment depicted in FIGS. 1 and 2 via the one or more networks 304. Additionally, in one or more embodiments, the server 302 can be located in and/or operated by the cloud environment depicted in FIGS. 1 and 2 (e.g., the cloud computing environment 50).

The one or more networks 304 can comprise wired and wireless networks, including, but not limited to, a cellular network, a wide area network (WAN) (e.g., the Internet) or a local area network (LAN). For example, the server 302 can communicate with the one or more input devices 306 (and vice versa) using virtually any desired wired or wireless technology including for example, but not limited to: cellular, WAN, wireless fidelity (Wi-Fi), Wi-Max, WLAN, Bluetooth technology, a combination thereof, and/or the like. Further, although in the embodiment shown the compound analysis component 308 can be provided on the one or more servers 302, it should be appreciated that the architecture of system 300 is not so limited. For example, the compound analysis component 308, or one or more components of compound analysis component 308, can be located at another computer device, such as another server device, a client device, etc.

The one or more input devices 306 can comprise one or more computerized devices, which can include, but are not limited to: personal computers, desktop computers 54B, laptop computers 54C, cellular telephones 54A (e.g., smart phones), computerized tablets (e.g., comprising a processor), smart watches, keyboards, touch screens, mice, a combination thereof, and/or the like. A user of the system 300 can utilize the one or more input devices 306 to input data into the system 300, thereby sharing (e.g., via a direct connection and/or via the one or more networks 304) said data with the server 302. For example, the one or more input devices 306 can send data to the reception component 310 (e.g., via a direct connection and/or via the one or more networks 304). The data can regard, for example: characteristics (e.g., chemical properties, physical properties, composition details, structure details, a combination thereof, and/or the like) associated with a target protein, characteristics (e.g., chemical properties, physical properties, composition details, structure details, a combination thereof, and/or the like) associated with eligible chemical compound candidates, a defined selection criteria (e.g., a number of experiment iterations), a combination thereof, and/or the like.

In one or more embodiments, the compound analysis component 308 can utilize the data provided by the one or more input devices 306 to analyze one or more chemical compounds and determine: actual parameter values (e.g., actual binding affinities) between one or more chemical compounds and the target protein; predicted parameter values (e.g., predicted binding affinities) between one or more chemical compounds and the target protein; one or more preferred chemical compounds (e.g., in association with the target protein); one or more preferred substructures of the chemical compounds that can affect the subject parameter value (e.g., binding affinity); a combination thereof; and/or the like. As used herein “binding affinity” can refer to a chemical compound's likelihood of physically and or chemically binding (e.g., via one or more covalent bonds) to a subject entity (e.g., a target protein). The compound analysis component 308 can analyze one or chemical compounds with regard to parameter values associated with a variety of applications, such as, but not limited to: binding affinities and/or gene expression.

The reception component 310 can receive the data inputted by a user of the system 300 via the one or more input devices 306. The reception component 310 can be operatively coupled to the one or more input devices 306 directly (e.g., via an electrical connection) or indirectly (e.g., via the one or more networks 304). Additionally, the reception component 310 can be operatively coupled to one or more components of the server 302 (e.g., one or more component associated with the compound analysis component 308, system bus 322, processor 324, and/or memory 320) directly (e.g., via an electrical connection) or indirectly (e.g., via the one or more networks 304).

The test component 312 can test one more chemical compounds to determine one or more respective parameter values (e.g., binding affinities) associated with the chemical compounds. The test component 312 can randomly select one or more chemical compounds from a library of chemical compounds to serve as test compounds. The number of chemical compounds selected to be test compounds can be defined by a default setting and/or by the data received (e.g., via the reception component 310) from the one or more input devices 306. Thus, in one or more embodiments, a user of the system 300 can define (e.g., via the one or more input devices 306) the number of chemical compounds selected (e.g., randomly selected) to be the initial test compounds.

The library of chemical compounds can be defined (e.g., by the test component 312) from a compound database 326 and/or from data received (e.g., via the reception component 310 and/or the one or more networks 304) from the one or more input devices 306. For example, the compound database 326 can comprise fingerprint features regarding any number of related and/or unrelated chemical compounds. As used herein, the term “fingerprint features” can refer to information regarding a subject chemical compound and/or subject target entity (e.g., target protein), which can include, but is not limited to: chemical properties, physical properties, composition details, structure details, a combination thereof, and/or the like. The compound database 326 can be stored in the memory 320 (e.g., as shown in FIG. 3) and/or can be stored outside the server 302 and accessed by the server 302 via the one or more networks 304.

The test component 312 can define the library of chemical compounds from the compound database 326 based on data received (e.g., via the reception component 310 and/or the one or more networks 304) from the one or more input devices 306. For example, the received data can regard one or more fingerprint features common to chemical compounds to be analyzed by the system 300 in association with the target protein. Based on the received data, the test component 312 can select one or more chemical compounds from the compound database 326 (e.g., along with respective fingerprint features) to be comprised within the library of chemical compounds used in conjunction with the subject test; thereby establishing a library of chemical compounds characterized by defined user input. In one or more other embodiments, the library of chemical compounds can be received (e.g., via the reception component 310 and/or the one or more networks 304) from the one or more input devices 306, rather than built from the compound database 326 by the test component 312.

The test component 312 can generate one or more experiments to determine a subject chemical compound's parameter value (e.g., binding affinity with regard to a subject entity, such as a target protein). Further, the test component 312 can subject the initial test compounds (e.g., randomly selected from the library of chemical compounds) to said test, and thereby determine respective parameter values (e.g., binding affinities) for the test compounds.

The model component 314 can generate one or more models based on one or more fingerprint features of the test compounds, one or more fingerprint features of a target entity (e.g., target protein), and/or the one or more determined parameter values (e.g., determined binding affinities). The one or more models can be, for example, regression analysis models generated using one or more machine learning technologies. As used herein, the term “machine learning technology” can refer to an application of artificial intelligence technologies to automatically learn and/or improve from an experience (e.g., training data) without explicit programming of the lesson learned and/or improved. In one or more embodiments, the model component 314 can generate the one or more models based further on historical data regarding past experiments (e.g., performed by the test component 312 regarding other chemical compound analyses). The historical data can be stored in a historical database 328, which can be located in the memory 320 (e.g., as shown in FIG. 3) and/or outside the server 302 (e.g., accessible via the one or more networks 304).

The prediction component 316 can determine one or more predicted parameter values (e.g., predicted binding affinities) for one or more respective untested chemical compounds comprised within the library of chemical compounds (e.g., chemical compounds that have not yet been tested by the test component 312 in the subject compound analysis) based on the one or more generated models and/or the fingerprint features of the untested chemical compounds. Further, the prediction component 316 can generate a respective confidence value for each predicted parameter value, which can be indicative of the predicted parameter value's likelihood of accuracy. Additionally, the prediction component 316 can identify one or more untested chemical compounds for a subsequent iteration of testing. For example, the prediction component 316 can utilize a value of information analysis, such as a knowledge gradient algorithm, to predict one or more parameter values (e.g., binding affinities) of untested chemical compounds within the chemical compound library and/or identify one or more untested chemical compounds characterized by having the largest value of information. As used herein, the term “value of information” can refer to a decision-making analysis regarding which can account for how much addressing a level of uncertainty will improve subsequent decisions (e.g., subsequent operations of machine learning technologies).

For example, the following Equation 1 and/or Equation 2 can facilitate the value of information analysis.

α˜N(θ,Σ). Equation 1

yₓⁿ⁺¹=μₓ+εₓⁿ⁺¹, Equation 2

Wherein “μ” can be a vector representing the predicted parameter values (e.g., predicted binding affinities) for the chemical compounds. Further, “μ” can equal “Xα”, wherein “X” can be a design matrix of all chemical compounds and “α” can be one or more underlying linear coefficients. In a Bayesian setting, for example, the prediction component 314 can assume that the linear coefficient vector “α” can follow a multivariate Gaussian distribution (e.g., as characterized by Equation 1; wherein “N” can represent a commonly known notation for normal distribution in mathematical contexts, and “(θ,Σ)” can represent estimated mean and covariance matrix for the coefficient vector). Thus, at each time “n”, regarding a subject chemical compound “x”, the prediction component 314 can observe a relationship characterized by Equation 2. In Equation 2, “μₓ” can be the true underlying parameter value (e.g., binding affinity) for the subject chemical compound “x”, and εₓⁿ⁺¹˜N(0,σₓ²), wherein the standard deviation “σₓ” can be known.

The knowledge gradient algorithm (e.g., exemplified in Equations 3a and 3b below) for linear belief models can characterize a fully sequential sampling policy that can facilitate determining the predicted parameter values (e.g., predicted binding affinities) and/or identifying an untested compound for further testing.

Equation 3

vₓ^{KG,n}= [symbol] (maxₓμₓⁿ|θⁿ,Σⁿ,xⁿ=x)−maxₓμₓⁿ (a)

x^{KG,n}=arg maxₓvₓ^{KG,n} (b)

As shown in Equation 3(a), “Vₓ^{KG,n}” can represent the knowledge gradient value for an untested chemical compound “x” at the n-th measurement. “μₓⁿ” can represent the predicted parameter value (e.g., predicted binding affinity) for chemical compound “x” at the n-th measurement. “(θⁿ,Σⁿ)” can be the estimated mean and covariance matrix for the linear coefficient at the n-th measurement. “xⁿ” can be the sampling chemical compound at time “n.” In Equation 3(b), the best chemical compound to sample at time “n” (e.g., a chemical compound of interest) can be the one with the maximum knowledge gradient value.

In addition, the parameters for linear coefficients “(θⁿ,Σⁿ)” can be updated via Recursive Least Squares (e.g., as characterized by Equation 4 below).

$${θ}^{n + 1} = {θ}^{n} + \frac{{ϵ}^{n + 1}}{{γ}^{n}} {\sum }^{n} {x}^{n} , \\ {\sum }^{n + 1} = {\sum }^{n} - \frac{1}{{γ}^{n}} {\sum }^{n} {{x}^{n} ( {x}^{n} )}^{T} {\sum }^{n} , \qquad Equation 4$$

Where ϵⁿ⁺¹=yⁿ⁺¹−(θⁿ)^{T}xⁿ and γⁿ=σₓ²+(xⁿ)^{T}Σⁿxⁿ. Further, “T” can represent a commonly known notation for taking a transpose in mathematical contexts.

In one or more embodiments, the prediction component 316 can utilize the one or more generated models in conjunction with a value of information analysis (e.g., such as the knowledge gradient algorithm characterized by Equation 1) to determine a marginal value of information for each untested chemical compound. For example, the value of information can regard a likelihood that testing a subject chemical compound can increase the accuracy of the one or more generated models and/or the one or more predicted parameter values (e.g., predicted binding affinities).

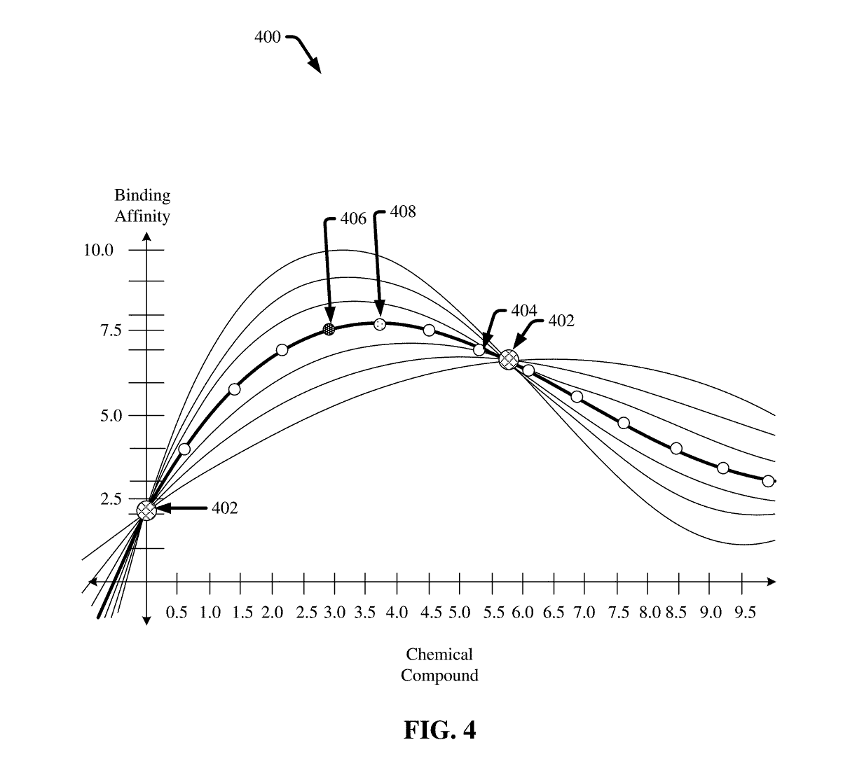

FIG. 4 illustrates a diagram on an example, non-limiting graph 400 that can depict the value of information analysis performed on one or more models in accordance with one or more embodiments described herein. Repetitive description of like elements employed in other embodiments described herein is omitted for sake of brevity. For example, graph 400 can be generated (e.g., via the prediction component 316) utilizing machine learning techniques and/or Equation 3. As shown in FIG. 4, the “y” axis of graph 400 can delineate the subject parameter value (e.g., binding affinities) while the “x” axis can delineate respective chemical compounds from the library of chemical compounds. First data points 402 can represent one or more determined parameter values for tested chemical compounds (e.g., determined binding affinities). Each line connecting the first data points 402 can represent possible parameter value trends (e.g., binding affinity trends) determined by the prediction component 316. Thus, the second data points 404 located on a line can represent one or more predicted parameter values for untested chemical compounds (e.g., predicted binding affinities). For example, the middle line can represent an average of the possible parameter value trends and serve as a basis for determining the second data points 404 (e.g., as shown in graph 400).

Based on the average possible parameter trend, the prediction component 316 can identify a chemical compound of interest, represented as a third data point 406 in FIG. 4. As used herein, the term “chemical compound of interest” can refer to a chemical compound with a maximum value of information, such as a chemical compound with the largest amount of parameter value deviation (e.g., binding affinity deviation) between possible parameter value trends. For instance, the chemical compound of interest can be an untested chemical compound with one or more predicted parameter values determined with a low level of confidence by the prediction component 316. As shown in FIG. 4, the chemical compound of interest (e.g., represented by third data point 406) can be a compound other than the chemical compound having the highest predicted parameter value (e.g., highest predicted binding affinity), represented as fourth data point 408.

Once the chemical compound of interest is identified by the prediction component 316, the test component 312 can repeat the subject experiment using the chemical compound of interest instead of the previously tested chemical compounds to generate an additional determined parameter value (e.g., determined binding affinity). Subsequently, the model component 314 can update the one or more generated models to include the additional determined parameter value (e.g., determined binding affinity) associated with the chemical compound of interest. Based on the one or more updated models, the prediction component 316 can determine: one or more new predicted parameter value trends (e.g., accounting for an additional first data point 402 associated with the newly determined parameter value) and/or one or more new second data points 404. Further, the prediction component 316 can identify a new chemical compound of interest based on the one or more updated models and the most recent predictions. A cycle of testing newly identified chemical compounds of interest, updating the one or more models, making new predictions, and/or performing a value of information analysis can repeat a for a defined number of iterations. Also, the defined number of iterations can be based on data received from the one or more input devices 306. For example, a user of the system 300 can utilize the one or more input devices 306 to define the total number of chemical compounds to be tested, wherein the compound analysis component 108 can repeatedly perform the cycle described herein until the total number of tested chemical compounds equal the defined amount set by the user.

Referring again to FIG. 3, the identification component 318 can identify one or more preferred chemical compounds based on the one or more models and/or predicted parameter values (e.g., predicted binding affinities). After the last iteration of the cycle, the identification component 318 can analyze the most up-to-date models (e.g., generated by model component 314) and/or the latest predictions (e.g., determined by prediction component 316) to identify the one or more preferred chemical compounds. For example, the one or more preferred compounds can be characterized as having a desired threshold of the tested parameter value (e.g., highest binding affinity). Further, the identification component 318 can identify the one or more preferred chemical compounds based on the predicted parameter values (e.g., determined by the prediction component 316) in addition to the determined parameter values (e.g., parameter values measured by the test component 312 via one or more experiments).

The number of preferred chemical compounds identified by the identification component 318 can be defined by data received by the one or more input devices 306. For instance, wherein the tested parameter value is binding affinity and data received from the one or more input devices 306 requests 20 preferred compounds, the identification component 318 can identify the 20 chemical compounds from the chemical compound library that have the highest binding affinity (e.g., determined binding affinity and/or predicted binding affinity) with the target entity (e.g., target protein). The identification component 318 can send the one or more preferred chemical compounds, the one or more determined parameter values (e.g., determined binding affinities), and/or the one or more predicted parameter values (e.g., predicted binding affinities) to the one or more input devices 306 (e.g., via the one or more networks) for a user of the system 300 to review. Additionally, the one or more predicted parameter values (e.g., predicted binding affinities) can be accompanied with one or more uncertainty values, which can designate the level of confidence associate with the respective predicted parameter values. Further the identification component 318 can rank the one or more preferred chemical compounds based on the parameter values.

With each iteration of the cycle, the one or more models and/or the various determinations of the prediction component 316 can become increasing accurate. Although the initially tested chemical compounds can be randomly selected, the additional tested chemical compounds (e.g., the chemical compounds of interest) can be selected based on the value of information that can be obtained from their testing. By performing a value based-analysis of which chemical compounds to select for testing, the compound analysis component 308 can efficiently increase the accuracy of generated models and/or predictions with a minimum amount of testing iterations. For example, each testing of a chemical compound of interest can provide the highest marginal utility as compared to a testing of another chemical compound during the subject iteration of the described cycle. Further, since a user of the system 300 can define the total number of tested chemical compounds, the user can manage costs associated with the testing. Thus, a user of the system 300 can choose a level of accuracy achieved by the compound analysis component 308 based on the user's budget.

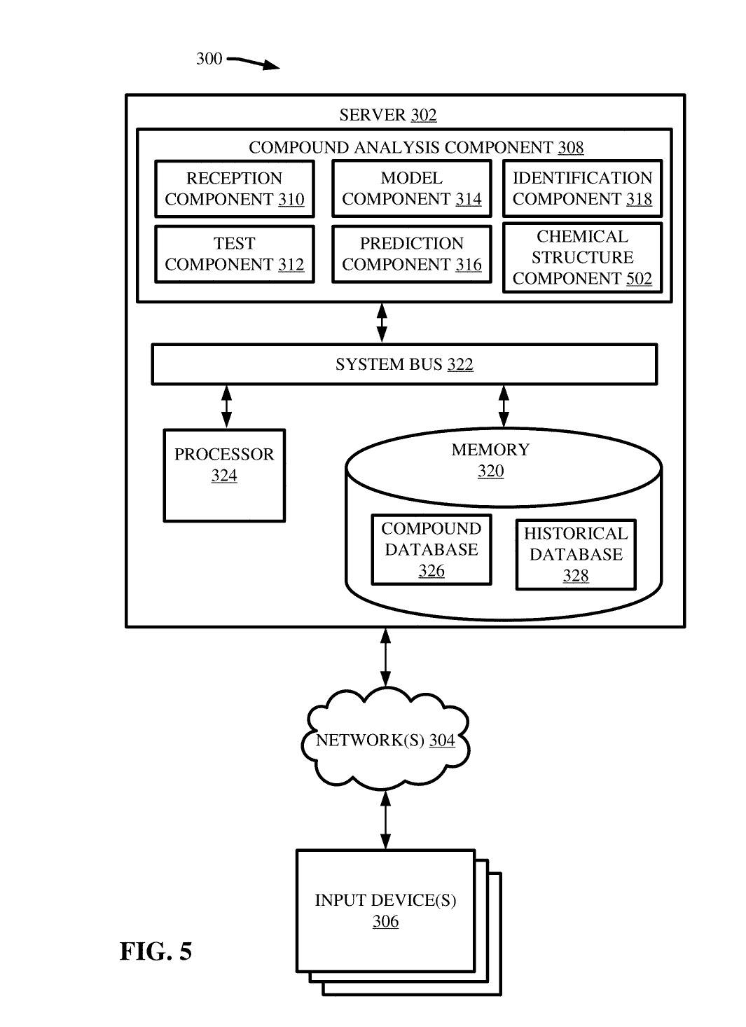

FIG. 5 illustrates a block diagram of example, non-limiting system 300 further comprising chemical structure component 502 in accordance with one or more embodiments described herein. Repetitive description of like elements employed in other embodiments described herein is omitted for sake of brevity.

Chemical structure component 502 can identify one or more chemical substructures that can affect the subject parameter value (e.g., binding affinity) of the chemical compounds. The one or more chemical substructures can regard portions of the preferred chemical compounds that attribute to the subject parameter value (e.g., binding affinity). For example, wherein the subject parameter value is binding affinity, the one or more chemical substructures can regard one or more chemical structure segments that contribute to a chemical compound's binding affinity regard a target entity (e.g., a target protein). For instance, the identified chemical substructure can regard a structure segment that is more commonly present in the preferred chemical compounds than the other chemical compounds from the library of chemical compounds. In other words, the identified chemical substructures can be indicative of a chemical compound characterized by a desired parameter, such as a desired binding affinity. By identifying chemical substructures that contribute to the subject parameter (e.g., increases binding affinity towards a target entity), the chemical structure component 502 can provide insight as to how chemical compounds can be modified to achieve desired performance characteristics. Thus, the compound analysis component 308 can identify preferred chemical compounds and/or chemical substructures that can affect a subject parameter value of chemical compounds (e.g., chemical substructures that can affect the binding affinity of chemical compounds with regard to a target protein).

The chemical structure component 502 can generate one or more chemical structure models. A respective chemical structure model can regard a respective chemical substructure comprised within one or more chemical compounds from the library of chemical compounds. As the subject parameter value is determined and/or predicted for chemical compounds, the chemical structure component 502 can account for the presence, and/or lack thereof, of the respective substructure.

Additionally, the chemical structure component 502 can rank the identified chemical substructures based on their likelihood to impact the subject parameter value, wherein said likelihood can increase with a subject chemical substructure's frequency in preferred chemical compounds. Moreover, the chemical structure component 502 can send the ranking of chemical substructures and/or the one or more structure models to the one or more input devices (e.g., via the one or more networks 304) for review by a user of the system 300.

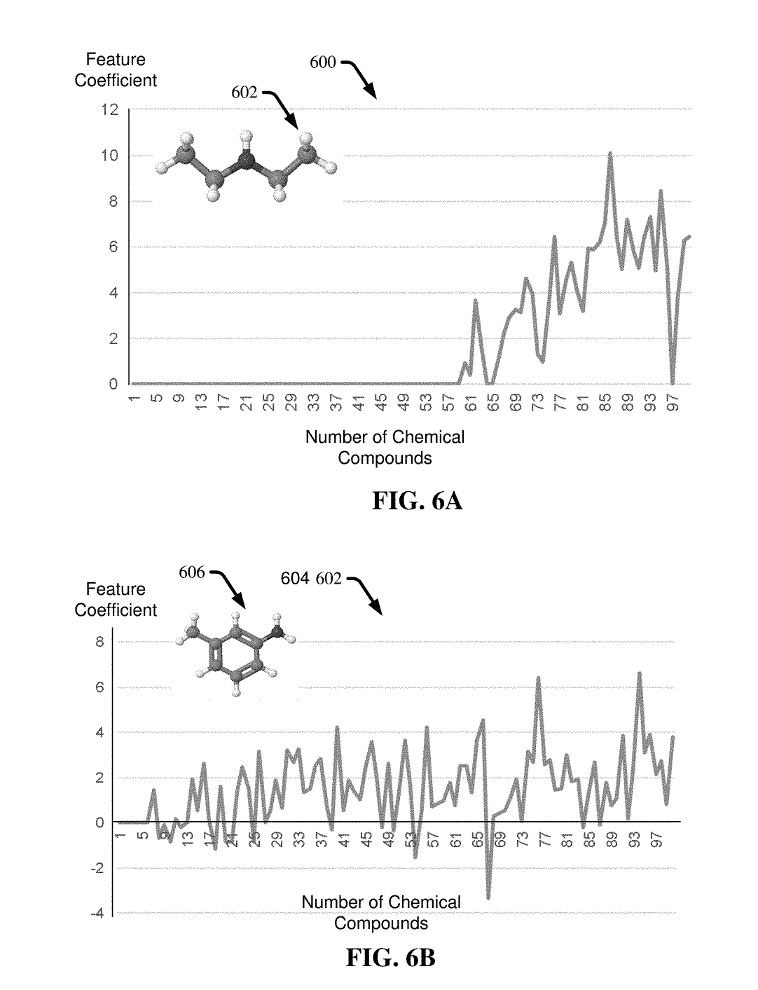

FIG. 6A illustrates a diagram of an example, non-limiting first structure model 600 that can be generated by the chemical structure component 502 in accordance with one or more embodiments described herein. Repetitive description of like elements employed in other embodiments described herein is omitted for sake of brevity. As shown in FIG. 6A, as the number chemical compounds increases (e.g., the number of chemical compounds meeting a threshold of the subject parameter value, such as a binding affinity threshold) the first structure model 600 can track the frequency of a first respective substructure's 602 presence in the subject chemical compounds.

FIG. 6B illustrates a diagram of an example, non-limiting second structure model 604 that can be generated by the chemical structure component 502 in accordance with one or more embodiments described herein. Repetitive description of like elements employed in other embodiments described herein is omitted for sake of brevity. As shown in FIG. 6B, as the number chemical compounds increases (e.g., the number of chemical compounds meeting a threshold of the subject parameter value, such as a binding affinity threshold) the second structure model 604 can track the frequency of a second respective substructure's 606 presence in the subject chemical compounds.

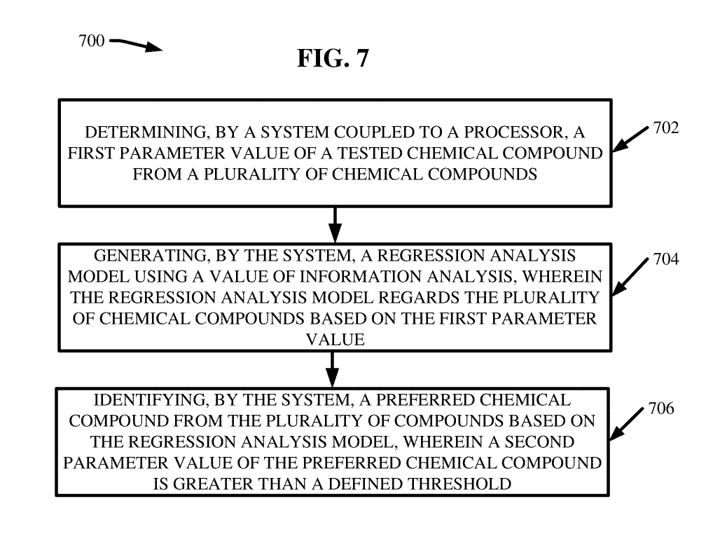

FIG. 7 illustrates a flow diagram of an example, non-limiting method 700 that can facilitate a compound analysis in accordance with one or more embodiments described herein. Repetitive description of like elements employed in other embodiments described herein is omitted for sake of brevity.

At 702, the method 700 can comprise determining, by a system 300 (e.g., via test component 312) coupled to a processor 324, one or more first parameter values (e.g., a binding affinity) of one or more tested chemical compound from a plurality of chemical compounds. The plurality of chemical compounds can comprise the library of chemical compounds described herein. Further, the one or more tested chemical compounds can be chosen randomly by the test component 312 and subject to one or more experiments to ascertain the one or more first parameter values. For example, the one or more experiments can ascertain respective binding affinities of the one or more tested compounds regarding a target entity (e.g., a target protein).

At 704, the method 700 can comprise generating, by the system 300 (e.g., via model component 314 and/or prediction component 316), one or more regression analysis models (e.g., graph 400) using a value of information analysis. The one or more regression analysis models can regard the plurality of chemical compounds based on the one or more respective first parameter values (e.g., respective binding affinities determined via the test component 312). Further, the generating at 704 can comprise machine learning technology such as an information value analysis (e.g., facilitated by a knowledge gradient algorithm such as Equation 3). In one or more embodiments, the regression analysis model can be used (e.g., by the prediction component 316) to determine one or more predicted parameter values (e.g., predicted binding affinities) regarding one or more untested chemical compounds from the plurality of chemical compounds. Additionally, in various embodiments the one or more predicted parameter values and/or the machine learning technology can be utilized (e.g., via the prediction component 316) to select chemical compounds of interest for further testing (e.g., as described herein regarding iterations of the cycle).

At 706, the method 700 can further comprise identifying, by the system 300 (e.g., identification component 318), one or more preferred chemical compounds based on, for example, the regression analysis model. The one or more preferred chemical compounds can be characterized as comprising respective parameter values (e.g., binding affinities) greater than a defined threshold. The defined threshold can be defined by a user of the system 300 via the one or more input devices 306. Additionally, the user can further define the number of cycle iterations that can be performed by the system 300 and/or the number of preferred chemical compounds to be identified.

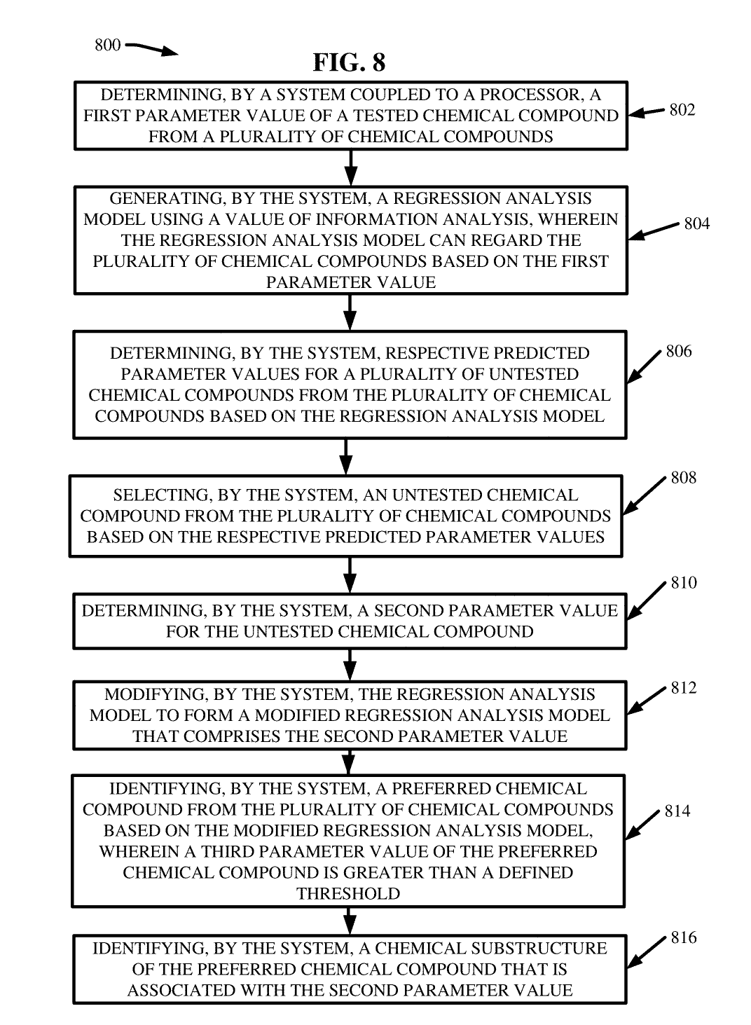

FIG. 8 illustrates a flow diagram of an example, non-limiting method 800 that can facilitate a compound analysis in accordance with one or more embodiments described herein. Repetitive description of like elements employed in other embodiments described herein is omitted for sake of brevity.

At 802, the method 800 can comprise determining, by a system 300 (e.g., via test component 312) coupled to a processor 324, one or more first parameter values (e.g., a binding affinity) of one or more tested chemical compound from a plurality of chemical compounds. The plurality of chemical compounds can comprise the library of chemical compounds described herein. Further, the one or more tested chemical compounds can be chosen randomly by the test component 312 and subject to one or more experiments to ascertain the one or more first parameter values. For example, the one or more experiments can ascertain respective binding affinities of the one or more tested compounds regarding a target entity (e.g., a target protein).

At 804, the method 800 can comprise generating, by the system 300 (e.g., via model component 314 and/or prediction component 316), one or more regression analysis models (e.g., graph 400) using a value of information analysis. The one or more regression analysis models can regard the plurality of chemical compounds based on the one or more respective first parameter values (e.g., respective binding affinities determined via the test component 312).

At 806, the method 800 can comprise determining, by the system 300 (e.g., via the prediction component 316), respective predicted parameter values (e.g., predicted binding affinities) for a plurality of untested chemical compounds from the plurality of chemical compounds based on, for example, the regression analysis model.

At 808, the method 800 can comprise selecting, by the system 300 (e.g., via the prediction component 316), one or more untested chemical compounds from the plurality of chemical compounds based on the respective predicted parameter values. For example, the prediction component 316 can select a chemical compound of interest from amongst the untested chemical compounds based on the value of information that can be obtained by testing said chemical compound of interest. For instance, the chemical compound of interest can be characterized by having a parameter value predicted with the lowest level of certainty amongst the untested chemical compounds.

At 810, the method 800 can comprise determining, by the system 300 (e.g., via the test component 312), a second parameter value for the untested chemical compound selected at 808; thereby reclassifying the chemical compound of interest from “untested” to “tested.” For example, the test component 312 can subject the chemical compound of interest to the same and/or a similar experiment as those chemical compounds initially tested in order to ascertain the second parameter value (e.g., the true binding affinity).

At 812, the method 800 can comprising modifying, by the system 300 (e.g., via the model component 314) the regression analysis mode to form a modified regression analysis model that comprises the second parameter value. Thus, the model component 314 can update the one or more generated models to reflect the newly ascertained parameter value (e.g., binding affinity) determined by the most recent iteration of testing.

In one or more embodiments, the determining at 806, the selecting at 808, the determining at 810, and/or the modifying at 812 can be defined as a cycle. The system 300 can perform numerous iterations of the cycle. In one or more embodiments, the number of iterations of the cycle can be defined by a user of the system 300 via the one or more input devices 306. With each cycle iteration, the one or more models and/or predictions generated by the system 300 can be come increasingly accurate. For example, confidence levels associated with each determined prediction (e.g., via the prediction component 316) can increase with each cycle iteration. By defining the number of cycle iterations, a user of the system 300 can chose a balance between accuracy and cost that best fits the user's fiscal budget.

At 814, the method 800 can comprise identifying, by the system 300 (e.g., via the identification component 318), one or more preferred chemical compounds from the plurality of chemical compounds based on the modified regression analysis model formed at 812 (e.g., determined parameter values and/or predicted parameter values). The respective parameter values of the one or more preferred chemical compounds can be greater than a defined threshold (e.g., defined by a user of the system 300 via the one or more input devices 306). In one or more embodiments, the identification component 318 can further rank the one or more preferred chemical compounds based on the respective parameter values.

At 816, the method 800 can further comprise identifying, by the system (e.g., chemical structure component 502), one or more chemical substructures (e.g., of the one or more preferred chemical compounds) that can be associated with the desired parameter value threshold (e.g., associated with binding affinity greater than the defined threshold). The one or more identified chemical substructures can be recognized by the chemical structure component 502 as having a high likelihood to influence the parameter value of a subject chemical compound. For example, the presence of identified chemical substructures in a subject compound can have a high likelihood of positively affecting the parameter value (e.g., such as increasing binding affinity regarding a target protein). In one or more embodiments, the chemical substructures can be identified using one or more generated structure models (e.g., first structure model 600 and/or second structure model 604) which can account for a frequency in which the identified chemical substructures are present in chemical compounds exhibiting desired performance characteristics (e.g., preferred chemical compounds). Additionally, the chemical structure component 502 can rank the chemical substructures based on their likelihood to affect the subject parameter value (e.g., binding affinity regarding a target protein).

One or more embodiments of the various computer processing systems, computer-implemented methods, apparatus and/or computer program products (e.g., such as system 300, method 700, and/or method 800) described herein can: predict parameter values for untested chemical compounds based on determined parameter values for tested chemical compounds; identify and/or rank preferred chemical compounds (e.g., either tested or untested) based on predicted parameter values and/or determined parameter values; perform one or more information value analyses to optimize marginal utility of each addition test subsequent to initial testing; and/or identify and/or rank chemical substructures, which can be recognized (e.g., based on their frequency within preferred chemical compounds) to affect a chemical compound's parameter vale.

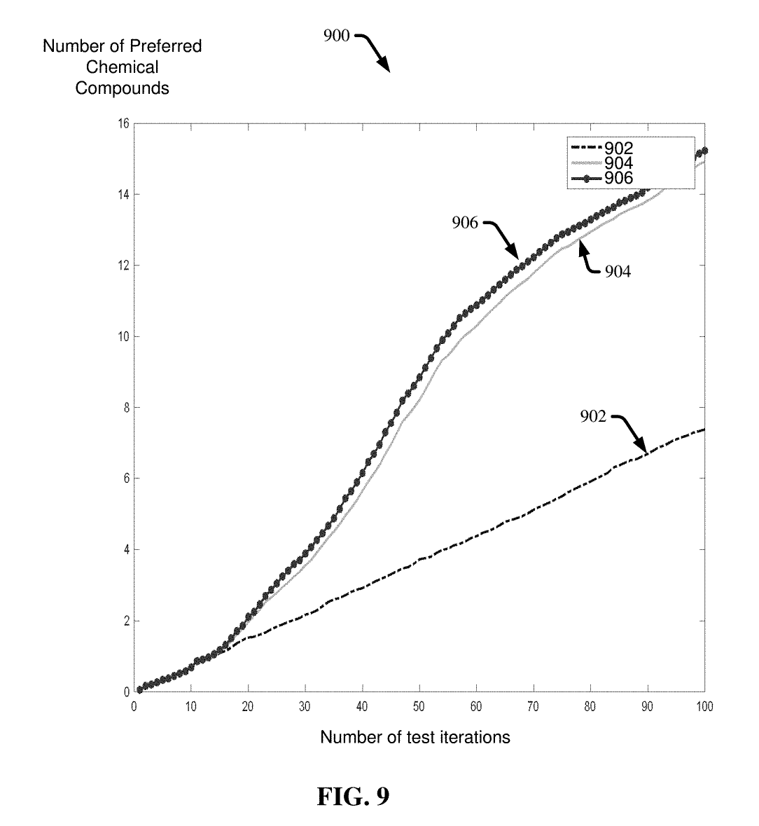

FIG. 9 illustrates a diagram of an example, non-limiting graph 900 that can depict the efficacy and/or efficiency of the system 300 and methods 700, 800 described herein. Repetitive description of like elements employed in other embodiments described herein is omitted for sake of brevity. For example, a compound analysis was preformed to identify preferred chemical compounds from a plurality of chemical compounds based on binding affinity with target protein, bromodomain-containing protein 4 (“BRD4”) (e.g., a protein that in humans can be encoded by the BRD4 gene). The compound analysis was performed in accordance with two conventional techniques and in accordance with the one or more embodiments described herein. Graph 900 depicts the results of the three compound analyses; wherein with the first line 902 can represent an exploration analysis method, the second line 904 can represent an exploitation analysis method, and the third line 906 can represent an analysis conducted in accordance with the various embodiments disclosed herein.

For each of the three analyses, 10 chemical compounds can be selected randomly for initial testing. The exploration method can subsequently continue to randomly select chemical compounds for each testing iteration. The exploitation method can predict parameter values based on determined parameter values of tested chemical compounds, and merely selects the chemical compound with the highest predicted parameter value (e.g., herein highest binding affinity) for each testing iteration. In contrast, the analysis conducted in accordance with the various embodiments described herein method predicts parameter values based on determined parameter values of tested chemical compounds and performs a value of information analysis (e.g., via a knowledge gradient algorithm) to determine which untested chemical compound is likely to yield the highest value of information due to its testing. Thus, the analysis conducted in accordance with the various embodiments described herein can select a chemical compound for each testing iteration based on more than mere random selection and/or highest predicted parameter value (e.g., based on the value of information that can be derived from testing the subject chemical compound). As shown in graph 900, the analysis conducted in accordance with the various embodiments described herein can outperform the conventional analyses techniques in each testing iteration.

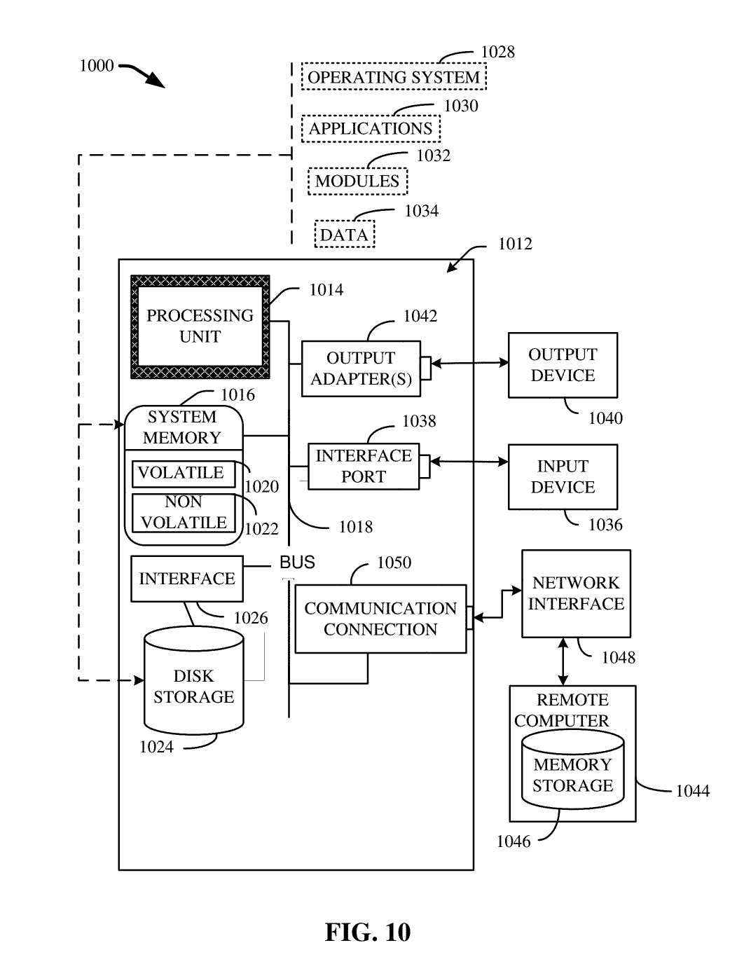

In order to provide a context for the various aspects of the disclosed subject matter, FIG. 10 as well as the following discussion are intended to provide a general description of a suitable environment in which the various aspects of the disclosed subject matter can be implemented. FIG. 10 illustrates a block diagram of an example, non-limiting operating environment in which one or more embodiments described herein can be facilitated. Repetitive description of like elements employed in other embodiments described herein is omitted for sake of brevity. With reference to FIG. 10, a suitable operating environment 1000 for implementing various aspects of this disclosure can include a computer 1012. The computer 1012 can also include a processing unit 1014, a system memory 1016, and a system bus 1018. The system bus 1018 can operably couple system components including, but not limited to, the system memory 1016 to the processing unit 1014. The processing unit 1014 can be any of various available processors. Dual microprocessors and other multiprocessor architectures also can be employed as the processing unit 1014. The system bus 1018 can be any of several types of bus structures including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire, and Small Computer Systems Interface (SCSI). The system memory 1016 can also include volatile memory 1020 and nonvolatile memory 1022. The basic input/output system (BIOS), containing the basic routines to transfer information between elements within the computer 1012, such as during start-up, can be stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 1020 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 1012 can also include removable/non-removable, volatile/non-volatile computer storage media. FIG. 10 illustrates, for example, a disk storage 1024. Disk storage 1024 can also include, but is not limited to, devices like a magnetic disk drive, floppy disk drive, tape drive, Jaz drive, Zip drive, LS-100 drive, flash memory card, or memory stick. The disk storage 1024 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 1024 to the system bus 1018, a removable or non-removable interface can be used, such as interface 1026. FIG. 10 also depicts software that can act as an intermediary between users and the basic computer resources described in the suitable operating environment 1000. Such software can also include, for example, an operating system 1028. Operating system 1028, which can be stored on disk storage 1024, acts to control and allocate resources of the computer 1012. System applications 1030 can take advantage of the management of resources by operating system 1028 through program modules 1032 and program data 1034, e.g., stored either in system memory 1016 or on disk storage 1024. It is to be appreciated that this disclosure can be implemented with various operating systems or combinations of operating systems. A user enters commands or information into the computer 1012 through one or more input devices 1036. Input devices 1036 can include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices can connect to the processing unit 1014 through the system bus 1018 via one or more interface ports 1038. The one or more Interface ports 1038 can include, for example, a serial port, a parallel port, a game port, and a universal serial bus (USB). One or more output devices 1040 can use some of the same type of ports as input device 1036. Thus, for example, a USB port can be used to provide input to computer 1012, and to output information from computer 1012 to an output device 1040. Output adapter 1042 can be provided to illustrate that there are some output devices 1040 like monitors, speakers, and printers, among other output devices 1040, which require special adapters. The output adapters 1042 can include, by way of illustration and not limitation, video and sound cards that provide a means of connection between the output device 1040 and the system bus 1018. It should be noted that other devices and/or systems of devices provide both input and output capabilities such as one or more remote computers 1044.

Computer 1012 can operate in a networked environment using logical connections to one or more remote computers, such as remote computer 1044. The remote computer 1044 can be a computer, a server, a router, a network PC, a workstation, a microprocessor based appliance, a peer device or other common network node and the like, and typically can also include many or all of the elements described relative to computer 1012. For purposes of brevity, only a memory storage device 1046 is illustrated with remote computer 1044. Remote computer 1044 can be logically connected to computer 1012 through a network interface 1048 and then physically connected via communication connection 1050. Further, operation can be distributed across multiple (local and remote) systems. Network interface 1048 can encompass wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). One or more communication connections 1050 refers to the hardware/software employed to connect the network interface 1048 to the system bus 1018. While communication connection 1050 is shown for illustrative clarity inside computer 1012, it can also be external to computer 1012. The hardware/software for connection to the network interface 1048 can also include, for exemplary purposes only, internal and external technologies such as, modems including regular telephone grade modems, cable modems and DSL modems, ISDN adapters, and Ethernet cards.

Embodiments of the present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various aspects of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to customize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which includes one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device including, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components including a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems, computer program products and computer-implemented methods. It is, of course, not possible to describe every conceivable combination of components, products and/or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a memory that stores computer executable components;
a processor, operably coupled to the memory, and that executes the computer executable components stored in the memory, wherein the computer executable components comprise:
a test component that determines a first parameter value of a tested chemical compound from a plurality of chemical compounds;
a model component that generates a regression analysis model using a value information analysis, wherein the regression analysis model regards the plurality of chemical compounds based on the first parameter value; and
an identification component that identifies a preferred chemical compound from the plurality of chemical compounds based on the regression analysis model, wherein a second parameter value of the preferred chemical compound is greater than a defined threshold.

2. The system of claim 1, wherein the first parameter value is a binding affinity regarding an affinity of the tested chemical compound to bind to a target protein.

3. The system of claim 1, wherein the computer executable components further comprise:
a prediction component that determines respective predicted parameter values for a plurality of untested chemical compounds from the plurality of chemical compounds based on the regression analysis model.

4. The system of claim 3, wherein the prediction component further selects an untested chemical compound from the plurality of untested chemical compounds based on the respective predicted parameter values, wherein the test component further determines a third parameter value for the untested chemical compound, and wherein the model component further modifies the regression analysis model to form a modified regression analysis model that comprises the third parameter value.

5. The system of claim 4, wherein the identification component identifies the preferred chemical compound based on the modified regression analysis model, and wherein the second parameter value of the preferred chemical compound is selected from a group consisting of the first parameter value, the respective predicted parameter values and the third parameter value.

6. The system of claim 5, wherein the identification component further generates a ranking of the plurality of chemical compounds based on the modified regression analysis model, and wherein the preferred chemical compound is comprised within the ranking.

7. The system of claim 1, wherein the computer executable components further comprise:
a chemical structure component that identifies a chemical substructure of the preferred chemical compound that is associated with the second parameter value.

8. A computer-implemented method, comprising:
determining, by a system operatively coupled to a processor, a first parameter value of a tested chemical compound from a plurality of chemical compounds;
generating, by the system, a regression analysis model using a value information analysis, wherein the regression analysis model regards the plurality of chemical compounds based on the first parameter value; and
identifying, by the system, a preferred chemical compound from the plurality of chemical compounds based on the regression analysis model, wherein a second parameter value of the preferred chemical compound is greater than a defined threshold.

9. The computer-implemented method of claim 8, wherein the first parameter value is a binding affinity regarding an affinity of the tested chemical compound to bind to a target protein.

10. The computer-implemented method of claim 8, further comprising:
determining, by the system, respective predicted parameter values for a plurality of untested chemical compounds from the plurality of chemical compounds based on the regression analysis model.

11. The computer-implemented method of claim 10, further comprising:
selecting, by the system, an untested chemical compound from the plurality of untested chemical compounds based on the respective predicted parameter values;
determining, by the system, a third parameter value for the untested chemical compound; and
modifying, by the system, the regression analysis model to form a modified regression analysis model that comprises the third parameter value.

12. The computer-implemented method of claim 11, wherein the identifying is based on the modified regression analysis model, and wherein the second parameter value of the preferred chemical compound is selected from a group consisting of the first parameter value, the respective predicted parameter values and the third parameter value.

13. The computer-implemented method of claim 12, further comprising:
identifying, by the system, a chemical substructure of the preferred chemical compound that is associated with the second parameter value.

14. The computer-implemented method of claim 11, further comprising:
generating, by the system, a ranking of the plurality of chemical compounds based on the modified regression analysis model, wherein the preferred chemical compound is comprised within the ranking.

15. A computer program product for chemical compound discovery, the computer program product comprising a computer readable storage medium having program instructions embodied therewith, the program instructions executable by a processor to cause the processor to:
determine a first parameter value of a tested chemical compound from a plurality of chemical compounds;
generate a regression analysis model using a value information analysis, wherein the regression analysis model regards the plurality of chemical compounds based on the first parameter value; and
identify a preferred chemical compound from the plurality of chemical compounds based on the regression analysis model, wherein a second parameter value of the preferred chemical compound is greater than a defined threshold.

16. The computer program product of claim 15, wherein the first parameter value is a binding affinity regarding an affinity of the tested chemical compound to bind to a target protein.

17. The computer program product of claim 15, wherein the program instructions further cause the processor to:
determine respective predicted parameter values for a plurality of untested chemical compounds from the plurality of chemical compounds based on the regression analysis model.

18. The computer program product of claim 17, wherein the program instructions further cause the processor to:
select an untested chemical compound from the plurality of untested chemical compounds based on the respective predicted parameter values;
determine a third parameter value for the untested chemical compound; and
modify the regression analysis model to form a modified regression analysis model that comprises the third parameter value.

19. The computer program product of claim 18, wherein the preferred chemical compound is identified based on the modified regression analysis model, and wherein the second parameter value of the preferred chemical compound is selected from a group consisting of the first parameter value, the respective predicted parameter values and the third parameter value.

20. The computer program product of claim 18, wherein the program instructions further cause the processor to:
generate a ranking of the plurality of chemical compounds based on the modified regression analysis model, wherein the preferred chemical compound is comprised within the ranking.
